(19) United States
(12) Patent Application Publication
(10) Pub. No.: US 2011/0196862 A1
(43) Pub. Date: Aug. 11, 2011

(54) OUTLINE-BASED COMPOSITION AND SEARCH OF PRESENTATION MATERIAL

(75) Inventors: Lawrence D. Bergman, Mount Kisco, NY (US); Jie Lu, Hawthorne, NY (US); Ravi B. Konuru, Tarrytown, NY (US)

(73) Assignee: International Business Machines Corporation, Armonk, NY (US)

(21) Appl. No.: 12/701,470

(22) Filed: Feb. 5, 2010

(51) Int. Cl. G06F 17/30

(52) U.S. Cl. 707/728; 707/769; 707/E17.014

(57) ABSTRACT

A method, system and computer program product for facilitating creation of a presentation by a user. In one embodiment, an input unit is configured to receive a target outline for a target presentation. An outline unit is configured to generate context-sensitive queries based, in part, on the hierarchical relationships of the outline topics in the target presentation. A search unit is configured to search a presentation repository using the context-sensitive queries for matching presentation slides that are relevant to the outline topics of the target presentation. An output unit is configured to present the matching presentation slides for evaluation by the user.

### BACKGROUND

Presentations created and shown using software tools such as IBM® Lotus® Symphony™ Presentations, Microsoft® PowerPoint®, and OpenOffice Impress are widely used, with millions produced each day. A presentation software tool is a program used to display information. Presentations are typically instantiated as files on a computer system and are typically considered to be divided into units of slides. For example, slides from presentations of individual products may be needed for inclusion in a marketing presentation and slides from presentations of various projects may be required for a management report.

Using today's tools, collating existing slides into new presentations can be a painful process. The user must first search for the slides. Current search tools are unable to operate at the level of individual slides, which causes two problems. First, because the search is at the presentation level, any presentation containing all search terms anywhere within it will be returned, even though the objective may be to obtain a single slide containing all search terms. Second, the user must sift through entire presentations returned by the search to find and extract relevant slides, which is often a time-consuming and difficult task.

Simply providing a slide-level search facility, however, is not a panacea. First, presentations often include slides whose content does not contain sufficient context for slide-level search. Consider searching for a slide that contains “goals” for an “accounting” project. Presentations on accounting may contain slides that describe goals (and contain the word “goals”), but do not have the word “accounting” in their content. Therefore, these slides may not be considered relevant when judged on their content alone without considering context, i.e., the presentations they come from. An additional complication is introduced when the desired material for a given topic spans multiple slides. For instance, a scenario or use case may consist of a sequence of slides, but the search terms “scenario” or “use case” may not be present on all slides of the sequence. A slide-level search method that lacks knowledge of presentation structure will be incapable of identifying and returning relevant groups of slides under such circumstances.

Once slides are located, a new presentation may be composed that uses these slides. Composition consists of two portions—the structure of the presentation is designed, and materials are created and/or inserted into the structure. Current tools provide almost no support for designing presentation structure. Users often structure presentations hierarchically. This can be seen in the large number of presentations that begin with an agenda or outline slide. Yet, most of today's tools represent a presentation solely as a linear sequence of slides.

Insertion of materials from multiple sources is typically accomplished by the laborious process of opening each source presentation, then cutting-and-pasting between source and target using separate windows for each.

### SUMMARY

An example embodiment of the present invention is a system for facilitating creation of a presentation by a user. The system includes an input unit configured to receive a target outline for a target presentation. The target outline includes outline topics in hierarchical relationships. An outline unit is configured to generate, using a computer processor, context-sensitive queries based in part on the hierarchical relationships of the outline topics in the target presentation. A search unit is configured to search a presentation repository using the context-sensitive queries for matching presentation slides that are relevant to the outline topics of the target presentation. An output unit is configured to present the matching presentation slides for evaluation by the user.

Another example embodiment of the invention is a method for facilitating creation of a presentation by a user. The method includes the step of receiving a target outline for a target presentation. The target outline includes outline topics in hierarchical relationships. The method also includes a generating step for generating context sensitive queries based in part on the hierarchical relationships of the outline topics. A searching step searches a presentation repository using the context sensitive queries for matching presentation slides that are relevant to the outline topics of the target presentation.

A presenting step presents the matching presentation slides for evaluation by the user.

Yet a further example embodiment of the invention is computer program product for facilitating creation of a presentation by a user. The computer program product includes computer readable program code configured to: receive a target outline for a target presentation; generate context sensitive queries based in part on the hierarchical relationships of the outline topics; search a presentation repository using the context sensitive queries for matching presentation slides that are relevant to the outline topics of the target presentation; and present the matching presentation slides for evaluation by the user.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an example system employing the present invention.

FIGS. 2-5 show an example user interface for presentation composition and search in accordance with the present invention.

FIG. 6 shows an example flowchart for facilitating creation of a presentation by a user.

FIG. 7 shows an example method used by a search unit to determine which slides to return as the search result for the query.

FIG. 8 shows additional operations included in the flowchart of FIG. 6.

FIG. 9 shows an output display from an outline inference module used to create hierarchal outlines of existing presentations.

FIG. 10 shows an exemplary computer configuration embodying the present invention.

### DETAILED DESCRIPTION

Aspects of the invention relate to an outline-based model for composition of presentations based on searching existing material. A user can compose a presentation by specifying a hierarchically-structured free-text outline. The outline can provide both search terms and contextual structure for a contextual outline-based search. The content to be searched can also be represented hierarchically, by means of extracted outlines which are reverse engineered from existing presentations.

An example of a software tool which may use an embodiment of the present invention may be available to users in a software-as-service or cloud environment.

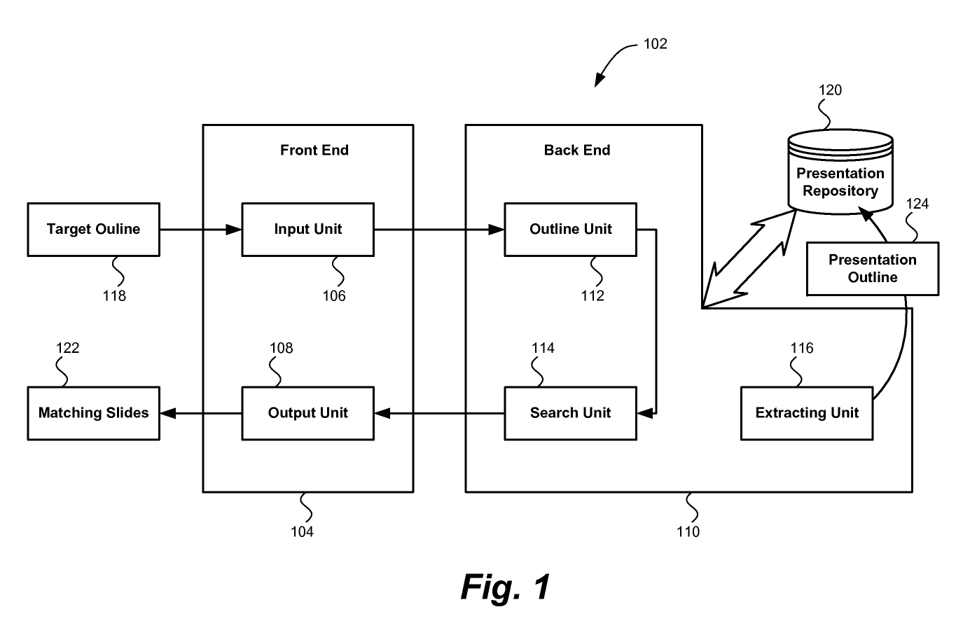

The present invention is described with reference to embodiments of the invention. Throughout the description of the invention reference is made to FIGS. 1-10.

Embodiments of the present invention provide support for search and composition of presentations through a new model of creating presentations from existing slides. Based on the common practice of structuring presentations via outlines, a methodology is presented that unifies search and composition. Broadly, a user creates a hierarchical outline of a “target” presentation being constructed. The hierarchical outline defines the structure of a presentation.

As the user creates the hierarchical outline, a query is constructed at each level of the hierarchical outline, with nested context from the outline used to scope the query. To address the shortcomings of single-slide search discussed above, a novel outline-based search technique is employed. The technique matches scoped queries against sets of existing presentations to find candidate slides or groups of slides by considering both presentation content and structure. Since the structure of currently existing presentations is not typically available, an outline-extraction technique to reverse engineer presentation structures is introduced that can be used for search. Presentations that are produced using the outline-based method described below can be automatically searchable without further outline extraction.

FIG. 1 illustrates an example system 102 for facilitating creation of a presentation by a user, as contemplated by the present invention. It is noted that the system 102 shown is just one example of various arrangements of the present invention and should not be interpreted as limiting the invention to any particular configuration.

The system 102 includes two subsystems comprised of five main components: a front end 104 containing an input unit 106 and output unit 108, and a back end 110 containing an outline unit 112, search unit 114, and extracting unit 116. In embodiments, units 102-116 may be software running on a computer. These units may be separate software programs, modules, or may be intertwined.

The input unit 106 is configured to receive a target outline 118 for a target presentation. The target presentation can be, for example, newly created or an existing presentation undergoing revision. The target outline 118 includes outline topics in hierarchical relationships. In an example embodiment, the user types a presentation outline into a user interface. The input unit 106 processes the user input and creates, for example, an XML-based representation of the outline to send to the outline processor.

The outline unit 112 is configured to generate, using a computer processor, context-sensitive queries based, in part, on the hierarchical relationships of the outline topics in the target presentation. For example, given a hierarchical outline, the outline unit 112 first constructs and updates a hierarchical tree structure to represent the outline. Next it extracts content and context information from the hierarchy to formulate contextual queries.

The search unit 114 is configured to search a presentation repository 120 using the context-sensitive queries for matching presentation slides that are relevant to the outline topics of the target presentation. Thus, the search unit 114 matches each query against context-sensitive representations of presentation content. As discussed in more detail below, the search unit 114 may be configured to estimate the relevance of a candidate slide to the query by using a combination of a cosine similarity function and a Boolean similarity function.

Query results are passed to the output unit 108, which displays sets of results and supports user interaction with them. For example, the output unit 108 is configured to present the matching presentation slides 122 for evaluation by the user. In a particular embodiment, the input unit 106 is configured to receive the matching slides 122 from the output unit 108 such that the user can add accepted slides to the target presentation. The input unit 106 may also be configured to propagate changes made by the user to the target outline through the outline unit 112, search unit 114, and output unit 108 to keep the search results up-to-date.

The extracting unit 116 is configured to automatically generate a presentation outline 124 for an existing presentation in the presentation repository 120. Thus, the extracting unit 116 is responsible for reverse engineering presentation outlines which are used for creating context-sensitive representations of presentation content. Reverse engineering a presentation outline constitutes generating a data structure representing the hierarchical relationships of presentation topics within an existing presentation.

For example, the extracting unit 116 reads and parses PowerPoint presentations stored in the repository 120, and infers an outline structure for each based on a variety of heuristic rules. In one embodiment, outline extraction is executed during an offline process or during times of low CPU usage.

The presentation outline 124 includes presentation topics in hierarchical relationships. In one embodiment of the invention, the extracting unit 116 and the outline unit 112 are configured to represent the hierarchical relationships of a presentation outline 124 as a tree of nodes. The extracting unit 116 and the outline unit 112 further integrate into the content of each node the content of all related nodes using a location-based weighting scheme.

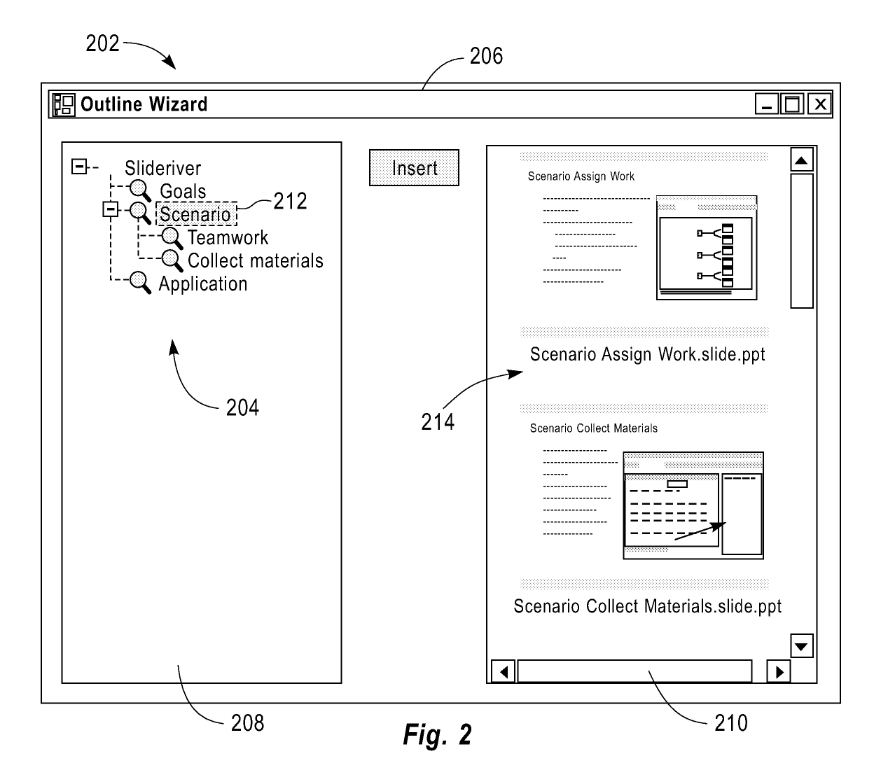

In FIGS. 2-5, an example user interface 202 for presentation composition and search is shown. The user interface 202 may include an “Outline Wizard” window 206. On a left panel 208 of the window 206, the user enters a hierarchal outline 204 of the target presentation. A wizard is a user interface that leads a user through steps.

In one embodiment, the top-most item is the presentation title (“SlideRiver” in FIG. 2), with presentation topics and subtopics contained in a nested tree structure. The outline tree is editable; with tree items indented or outdented via keystrokes.

For example, consider a user who wants to construct a presentation detailing the “SlideRiver” software system. She creates a hierarchal outline 204 that includes the title of the presentation (“SlideRiver”), topics (“Goals,” “Scenario,” “Application”), and subtopics (“Teamwork” and “Collect materials”).

As the user completes entry of each topic, a search is initiated. In one embodiment, when results are obtained, a spyglass icon is presented to the left of the topic. FIG. 2 shows search results 214 returned for the highlighted topic “Scenario” 212 presented in the right-hand panel 210 as thumbnails. Each thumbnail may represent a single slide.

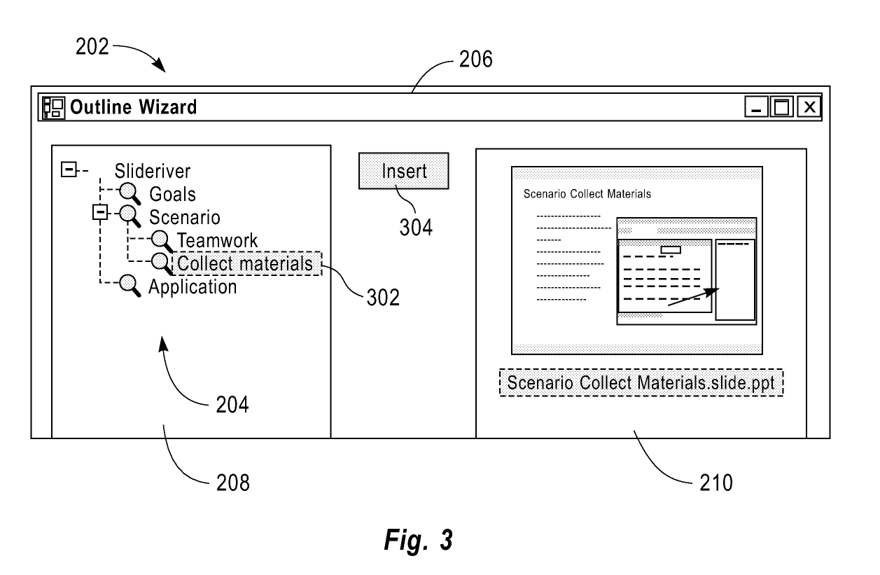

The hierarchically structured outline 204 provides context used for search. In FIG. 3, for example, the highlighted topic 302 specifies that a “Collect materials” scenario is being sought for the SlideRiver presentation. The user interface 202 derives contextual queries based on the outline 204, conducts search over a repository of presentations, associates sets of search results with these contextual queries, and supplies them in-context.

By clicking on a topic within the outline 204, the user is able to preview the content of retrieved slides associated with that topic, as shown in FIGS. 2 and 3. The user interface 202 automatically constructs a series of outline slides for the presentation based on the user-specified outline 204.

In one embodiment, the user can select any of the thumbnail slides from the search results, as shown in FIG. 3. The selected slide(s) are inserted into the target presentation by clicking on the “Insert” button 304. The user may see a larger preview of a slide thumbnail by double-clicking on it. The preview panel may also contain an “Insert” button.

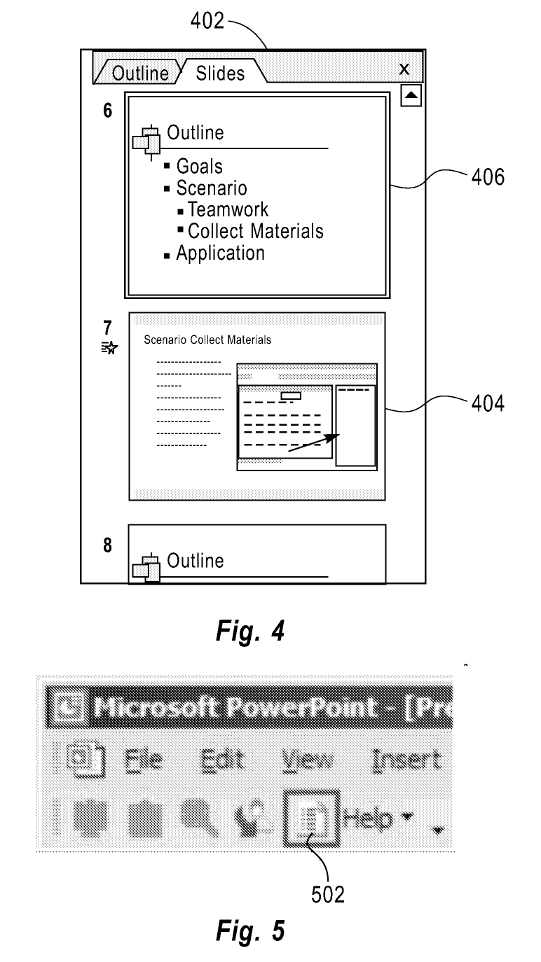

FIG. 4 shows a portion of the target presentation user interface 402 containing the presentation being constructed. Outline slides 404 may be automatically inserted for each topic, showing the current topic (“Collect materials” in FIG. 4) highlighted within the full outline context 406. Slides that have been inserted may be displayed immediately following the topic they represent.

As show in FIG. 5, the user interface may include a PowerPoint plug-in. When the user clicks the Outline Wizard toolbar button 502, a PowerPoint presentation is initiated, and the Outline Wizard user interface is displayed (see FIGS. 2 and 3).

Compared to existing tools, the example user interface offers several benefits. First, it provides a mechanism for the user to design a presentation using a much more structured representation than that provided by traditional linear presentation tools. Second, the user interface automatically formulates queries and conducts search based on the outline specified by the user, which frees her from manually crafting and issuing multiple queries to search for content. Third, the user interface allows the user to easily inspect search results, and incorporate selected results into the presentation without cutting-and-pasting between multiple windows.

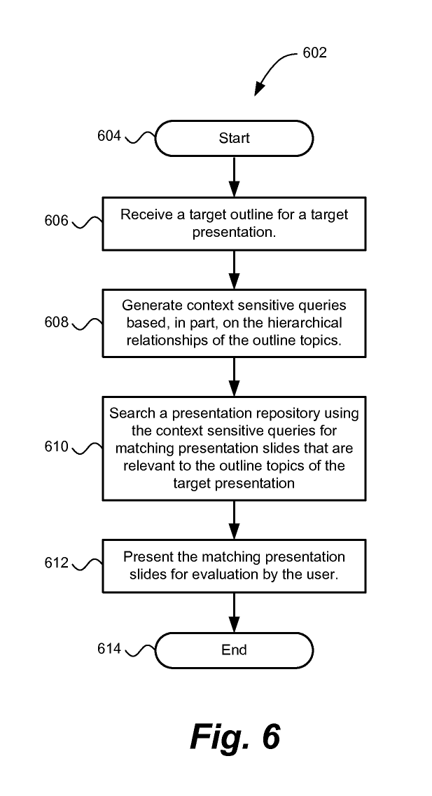

Another embodiment of the invention is a method for facilitating creation of a presentation by a user, which is now described with reference to flowchart 602 of FIG. 6. The method begins at Block 604 and includes receiving a target outline for a target presentation at Block 606. As discussed above, the target outline can include outline topics in hierarchical relationships.

After Block 606 is completed, control passes to Block 608. At Block 608, a computer processor generates context sensitive queries based, in part, on the hierarchical relationships of the outline topics.

In one embodiment, any outline, whether user-specified, or derived from an existing presentation, is represented by a hierarchical tree of nodes. For a user-specified outline, a node corresponds to one topic in the hierarchical outline, e.g., “Scenario,” “Teamwork,” etc. Such nodes are referred to as query nodes, since they are used to automatically formulate searches. For an outline derived from an existing presentation in the repository, a node corresponds to a presentation element, which can be the entire presentation, a group of slides associated with a topic in the presentation outline, or a single slide. Such nodes are referred to as repository nodes.

The content of a node is determined by the type of the node. For a repository node representing a presentation, its content corresponds to the title of the presentation. For a repository node that represents a slide or a query node that represents an outline topic, its content is the text contained in the slide or the topic.

For a repository node that represents a group of slides, its content corresponds to the group title, which comes from the presentation outline topic with which these slides are associated.

The links between nodes in the hierarchical tree are determined by the parent-child relations as indicated by the outline structure. A top-level outline topic such as is a child of the node that corresponds to the entire presentation. An outline data structure organizes all the nodes of a hierarchical outline, and provides methods for its navigation.

In a particular embodiment, the representation of a user-specified outline is created and updated dynamically as the user creates and edits the outline structure. The representations of presentation elements in the repository are created and indexed by an offline process and are loaded on demand at run time.

A vector space model may be used to capture both content and context of query nodes and repository nodes. The context of a node is defined as the aggregate content of all of its ancestors and descendants in the hierarchical tree of nodes. A node's context-sensitive vector integrates the node's content with its context.

The context-sensitive vector is created in two steps. First, the content term vector of the node is created, based on the content it encodes, without considering its context. Second, this content term vector is integrated with all content term vectors from the node's context to create its context-sensitive vector. These two steps are described in detail below.

A node's content term vector is constructed by removing punctuation marks and stopwords, then stemming the set of words and quoted strings. For a query node, the weight of a term is determined by the term's frequency in the node's content. For a repository node, the weight of a term is computed based on its frequency in the node's content as well as its location and overall popularity in the presentation. Location refers to the hierarchical nesting level of a term, from inner to outer-slide content, slide title, outline topic, presentation title. Following the common practice of assigning location-based term weights in information retrieval, a term is given a higher weight when it occurs at an outer level than when it occurs at an inner level in the hierarchy.

For example, the location-based weight w_{location} of a term t in a node n's content is set to 1.0 for the node's content that corresponds to presentation title, 0.8 for outline topic, 0.6 for slide title, and 0.4 for slide content.

A term's overall popularity is inversely related to its discriminative power, which is typically measured by inverse document frequency (idf) in traditional information retrieval. Because the basic result unit for outline-based search is a slide, we use inverse slide frequency isf to measure a term t's discriminative power within a presentation p:

isf(p,t)=log(Nₚ/N_{p,t})

where Nₚ is the total number of slides in the presentation p, and N_{p,t} is the number of p's slides containing the term t.

The weight w of a term t in the content term vector v_{c} of the node n for a presentation element is therefore calculated as the product of the term's frequency f in the node's content, its location-based weight w_{location}, and its inverse slide frequency isf in the presentation to which the node belongs:

w(t)=f(t)×w_{location}(t)×isf(p,t)

To create a context-sensitive vector vₛ, for the node n, its content term vector v_{c} is integrated with all of the content term vectors from n's context as follows:

vₛ(n)=v_{c}(n)+Σ_{n′εcontext(n)}min(0,1−0.2d(n,n′))×v_{c}(n′)

where each content term vector v_{c}(n′) from the context is discounted based on the distance (i.e., path length) d(n, n′) between its node n′ and the targeted node n in the hierarchical tree, so that terms located closer to the targeted node are given higher weights. The discount factor of 0.2 is determined empirically.

As with the node representations, context-sensitive vectors that represent queries are created dynamically as the user edits the outline; vectors that represent presentation elements are created and indexed offline then dynamically loaded at run time.

After Block 608 is completed, control passes to Block 610. At Block 610, a presentation repository is searched using the context sensitive queries for matching presentation slides that are relevant to the outline topics of the target presentation.

In one embodiment, as the user creates and edits an outline in the interface, the outline topics are dynamically sent to the outline unit, which updates the hierarchical representation created for the outline, extracts from it a set of nodes for topics that have new or changed content or context, and creates context-sensitive query vectors for these nodes. Each query vector is passed to the search unit, which conducts search in three steps. First, the query is sent to a text search engine, which uses, for example, the traditional tf.idf-based ranking algorithm to rank its indexed presentations and returns a list of top-ranked presentations as candidates. Second, the search unit retrieves the context-sensitive vectors of the presentation elements contained in these candidate presentations, and estimates the relevance r of each presentation element e to the query q based on a combination of the standard cosine similarity Sim_{cos} between the query vector and the vector of the presentation element, the Boolean similarity Sim_{bool} between them, and the relevance score of the presentation p to which the presentation element belongs:

r(e,q)=Sim_{cos}(vₛ(e),vₛ(q))×sim_{bool}/(vₛ(e),vₛ(q))×r(p,q)

The Boolean similarity Sim_{bool} is calculated as the percentage of query terms that are matched. It is introduced to favor presentation elements that match all query terms. Third, the outline searcher ranks the presentation elements by their relevance scores, and generates a result list.

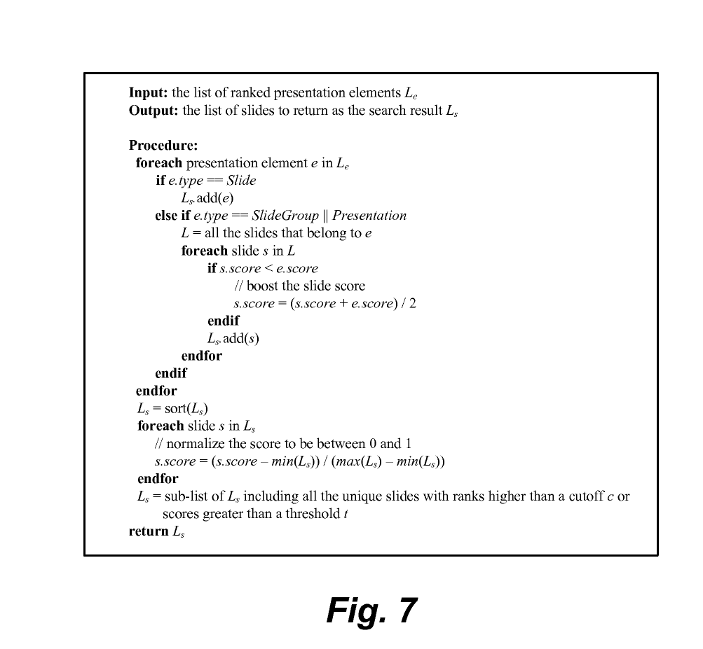

In one embodiment, the basic result unit for outline-based search is a slide. FIG. 7 illustrates an example method used by the search unit to determine which slides to return as the search result for the query. This method uses the scores of the presentation elements at the level of presentation or slide group to boost the scores of the slides that belong to them, so that a slide is more likely to be returned when it belongs to a presentation or a slide group that is deemed relevant, even if this slide seems less relevant judged on its own. Slides which exceed a rank-based cutoff, c, or a score-based threshold, t, (both constants determined empirically) are included in a ranked list of return results.

In one embodiment, an outline similarity metric S for comparing two outlines o₁ and o₂ representing a presentation p is calculated. The similarity metric calculates the average degree of agreement between two outlines as follows:

S(o₁,o₂)=Σ_{sεp}A(t₁(S),t₂(S))/|p|

where for each slide s in p, t₁(s) and t₂(s) denote the agenda topics to which s is assigned in the two representations, A denotes the agreement between them, and |p| denotes the number of slides in the presentation p.

A has a non-zero value if t₁(s) and t₂(s) are located on the same sub-tree in the topic hierarchy of p's agenda, with the degree of agreement discounted by a measure of their “distance” from each other. Specifically, it is computed as:

A(t₁,t₂)=1−min(1,0.2×D(t₁,t₂))

where D is a measure of the “distance” between two agenda topics in the presentation agenda's topic hierarchy:

D(t₁,t₂)=max(d(t*,t₁),d(t*,t₂))

where t* is the closest common topic to t₁ and t₂ among the set of agenda topics that includes t₁, t₂ and their ancestors in the topic hierarchy, and d(•, •) is the distance (i.e., path length) between two topics. If t₁ and t₂ refer to the same topic, D is set to 0. The discount factor of 0.2 is determined empirically.

If a slide is assigned to a topic by the outline extractor but is left unassigned by manual assignment, A is set to 0.5. If a slide is assigned manually but is left unassigned automatically, A is set to 0.

For each presentation in the development set, similarity scores are calculated on three pairs—comparing the two manual assignments, and then comparing the automatic extract with each of the manual assignments.

Returning to FIG. 6, after Block 610 is completed, control passes to Block 612. At Block 612, the matching presentation slides are presented for evaluation by the user. As discussed in detail above, a user interface may be used to display slides from a presentation repository matching the hierarchal outline to the user. The user can then select the desired matching slides for inclusion in the target presentation.

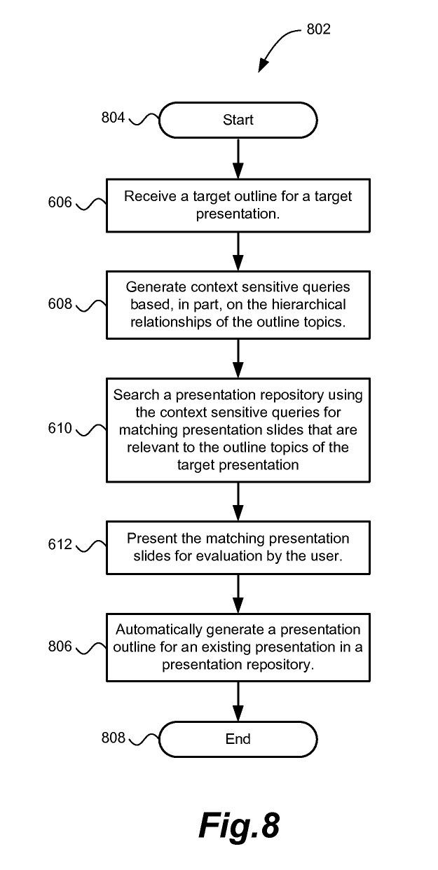

In another method embodiment, which is now described with reference to flowchart 802 of FIG. 8, the method begins at Block 804. The method may include the steps of FIG. 6 at Blocks 606, 608, 610 and 612. The method may additionally include automatically generating a presentation outline for an existing presentation in the presentation repository at Block 806. The presentation outline includes presentation topics in hierarchical relationships. The method ends at Block 808.

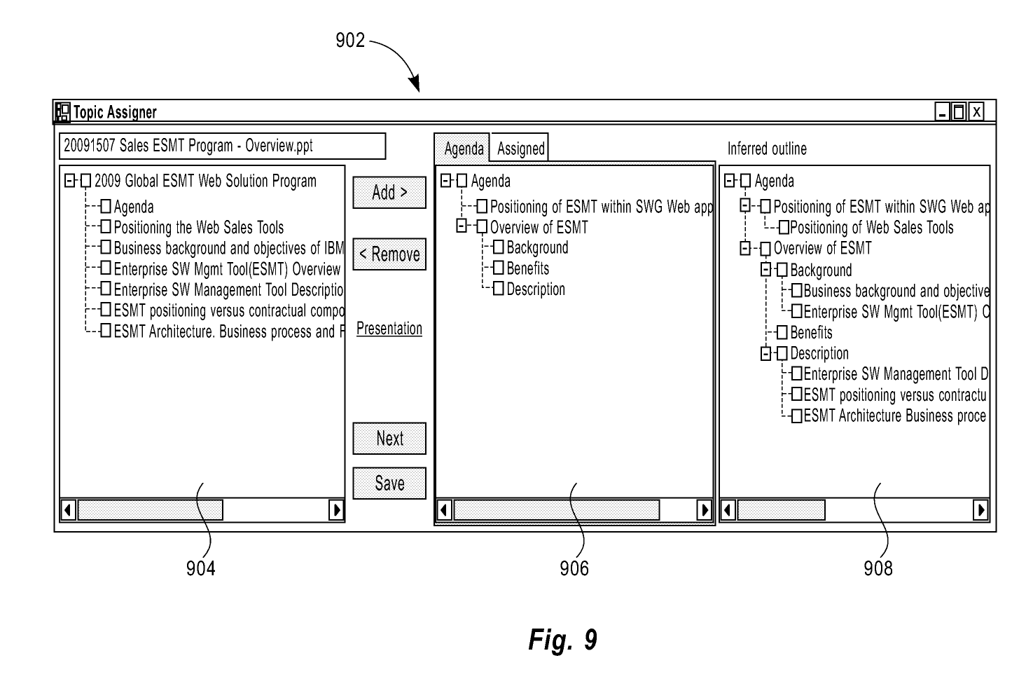

In one embodiment, an outline inference module is used to create hierarchal outlines of existing presentations. FIG. 9 shows a display 902 of output from the module. The leftmost panel 904 displays slide titles, one line per slide. The middle panel 906 shows the topics on the agenda slide. The rightmost panel 908 shows the inferred outline. Topics from the agenda slide have become group titles, with each group containing zero or more slides.

The inference module extracts topics from an agenda slide, then assigns individual slides to agenda topics using a segmentation-based algorithm, which assumes that slides appear in the same order as agenda topics (usually, but not universally true). The segmentation algorithm seeks to find a starting slide for each topic, and assumes that all slides that follow belong to the topic, until the slide that starts the next topic. Note that this approach allows hierarchically nested topics.

For a presentation with a single agenda, the correspondences between slides and agenda topics are determined by matching agenda topics with slide titles based on the keywords extracted from each. Keywords are stopped with a stemmed stopword list. Quoted strings are retained intact. A match score M between a slide title S and an agenda topic A is computed as the percentage of keywords from the slide title found in the topic:

M(S,A)=|Kₛ∩Kₐ|/|Kₛ|

where Kₛ is the set of keywords in the slide title, and Kₐ is the set of keywords in the agenda topic. Any value of M(S, A) that exceeds an empirically determined cutoff level is considered a match.

When there are multiple identical or near-identical agenda slides in a presentation, the inference module uses these slides to segment the presentation; each marks the start of a topic. The topic associated with each agenda slide is identified by recognizing color or bold highlighting.

If no color/bold highlighting is found, and the number of agenda slides is equal to the number of agenda topics, it is assumed that a one-to-one correspondence between agenda slides and topics. Otherwise, the inference module ignores the multiple agenda slides, and segments the presentation via title matching as if it contains a single agenda slide, as described earlier.

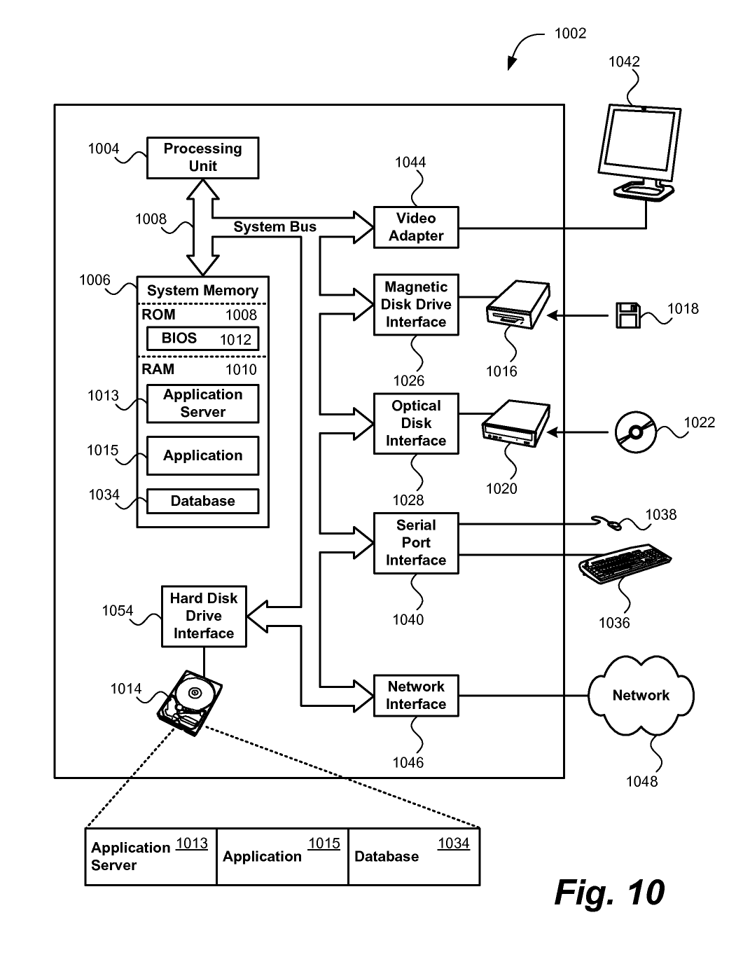

With reference to FIG. 10, an example of a computer 1002 embodying the present invention is shown. One computer 1002 in which the present invention is potentially useful encompasses a general-purpose computer. Examples of such computers include SPARC(r) systems offered by Sun Microsystems, Inc. and Pentium(r) based computers available from Lenovo Corp. and various other computer manufacturers. SPARC is a registered trademark of Oracle Corporation and Pentium is a registered trademark of Intel Corporation.

The computer 1002 includes a processing unit 1004, a system memory 1006, and a system bus 1008 that couples the system memory 1006 to the processing unit 1004. The system memory 1006 includes read only memory (ROM) 1008 and random access memory (RAM) 1010. A basic input/output system (BIOS) 1012, containing the basic routines that help to transfer information between elements within the computer 1002, such as during start-up, is stored in ROM 1008.

The computer 1002 further includes a hard disk drive 1014, a magnetic disk drive 1016 (to read from and write to a removable magnetic disk 1018), and an optical disk drive 1020 (for reading a CD-ROM disk 1022 or to read from and write to other optical media). The hard disk drive 1014, magnetic disk drive 1016, and optical disk drive 1020 are connected to the system bus 1008 by a hard disk interface 1024, a magnetic disk interface 1026, and an optical disk interface 1028, respectively. The drives and their associated computer-readable media provide nonvolatile storage for the computer 1002. Although computer-readable media refers to a hard disk, removable magnetic media and removable optical media, it should be appreciated by those skilled in the art that other types of media that are readable by a computer, such as flash memory cards, may also be used in the illustrative computer 1002.

Programs and data may be stored in the drives and RAM 1010, including an application server 1013, one or more applications 1015, a relational database 1034, and other program modules and data (not shown). The application server 1013 is configured, for example, provide the application 1015 over a network 1048.

A user may enter commands and information into the computer 1002 through a keyboard 1036 and pointing device, such as a mouse 1038. Other input devices (not shown) may include a microphone, modem, joystick, game pad, satellite dish, scanner, or the like. These and other input devices are often connected to the processing unit through a serial port interface 1040 that is coupled to the system bus 1008.

A display device 1042 is also connected to the system bus 1008 via an interface, such as a video adapter 1044. In addition to the display device, the computer 1002 may include other peripheral output devices (not shown), such as speakers and printers.

The computer 1002 operates in a networked environment using logical connections to one or more remote devices. The remote device may be a server, a router, a peer device or other common network node. When used in a networking environment, the computer 1002 is typically connected to a network 1048 through a network interface 1046. In a network environment, program modules depicted relative to the computer 1002, or portions thereof, may be stored in one or more remote memory storage devices. The network 1048 may be any of various types of networks known in the art, including local area networks (LANs), wide area networks (WANs), wired and/or wireless networks. The network 1048 may employ various configurations known in the art, including by example and without limitation TCP/IP, Wi-Fi®, Bluetooth® piconets, token ring, optical and microwave. Wi-Fi is a registered trademark of the Wi-Fi Alliance, located in Austin, Tex. Bluetooth is a registered trademark of Bluetooth SIG, Inc., located in Bellevue, Wash. It is noted that the present invention does not require the existence of a network.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preferred embodiments to the invention has been described, it will be understood that those skilled in the art, both now and in the future, may make various improvements and enhancements which fall within the scope of the claims which follow. For example, although the system as presented operates on English-language text, there is nothing in either the extraction or search algorithms that is inherently language-dependent. Thus, the claims should be construed to maintain the proper protection for the invention first described. Microsoft and PowerPoint are trademarks of Microsoft Corporation in the United States and other countries.

What is claimed is:

1. A system for facilitating creation of a presentation by a user, the system comprising:
an input unit configured to receive a target outline for a target presentation, the target outline including outline topics in hierarchical relationships;
an outline unit configured to generate, using a computer processor, context-sensitive queries based, in part, on the hierarchical relationships of the outline topics in the target presentation;
a search unit configured to search a presentation repository using the context-sensitive queries for matching presentation slides that are relevant to the outline topics of the target presentation; and
an output unit configured to present the matching presentation slides for evaluation by the user.

2. The system of claim 1, further comprising an extracting unit configured to automatically generate a presentation outline for an existing presentation in the presentation repository, the presentation outline including presentation topics in hierarchical relationships.

3. The system of claim 2, wherein the extracting unit and the outline unit are configured to represent the hierarchical relationships of a presentation outline as a tree of nodes, and to integrate into the content of each node the content of all related nodes using a location-based weighting scheme.

4. The system of claim 1, wherein the search unit is configured to estimate the relevance of a candidate slide to the query by using a combination of a cosine similarity function and a Boolean similarity function.

5. The system of claim 1, wherein the input unit is configured to propagate changes made by the user to the target outline through the outline unit, search unit, and output unit to keep the search results up-to-date.

6. The system of claim 1, wherein the input unit is configured to receive the matching slides from the output unit such that the user can add accepted slides to the target presentation.

7. A method for facilitating creation of a presentation by a user, the method comprising:
receiving a target outline for a target presentation, the target outline including outline topics in hierarchical relationships;
generating, by a computer processor, context sensitive queries based, in part, on the hierarchical relationships of the outline topics;
searching a presentation repository using the context sensitive queries for matching presentation slides that are relevant to the outline topics of the target presentation; and
presenting the matching presentation slides for evaluation by the user.

8. The method of claim 7, further comprising automatically generating a presentation outline for an existing presentation in the presentation repository, the presentation outline including presentation topics in hierarchical relationships.

9. The method of claim 7, wherein the hierarchical relationships of a presentation outline are represented as a tree of nodes.

10. The method of claim 9, wherein generating the context sensitive queries includes integrating into the content of each node the content of all related nodes using a location-based weighting scheme.

11. The method of claim 7, wherein searching the presentation repository includes estimating the relevance of a candidate slide to the query by using a combination of a cosine similarity function and a Boolean similarity function.

12. The method of claim 7, wherein receiving the target outline for the target presentation includes repeating the generating, searching and presenting steps to keep the search results up-to-date.

13. The method of claim 7, further comprising receiving user indication to add one or more of the matching presentation slides to the target presentation.

14. A computer program product for facilitating creation of a presentation by a user, the computer program product comprising:
a computer readable storage medium having computer readable program code embodied therewith, the computer readable program code configured to:
receive a target outline for a target presentation, the target outline including outline topics in hierarchical relationships;
generate context sensitive queries based, in part, on the hierarchical relationships of the outline topics;
search a presentation repository using the context sensitive queries for matching presentation slides that are relevant to the outline topics of the target presentation; and
present the matching presentation slides for evaluation by the user.

15. The computer program product of claim 14, further comprising automatically generating a presentation outline for an existing presentation in the presentation repository, the presentation outline including presentation topics in hierarchical relationships.

16. The computer program product of claim 14, wherein the hierarchical relationships of a presentation outline are represented as a tree of nodes.

17. The computer program product of claim 16, wherein generating the context sensitive queries includes integrating into the content of each node the content of all related nodes using a location-based weighting scheme.

18. The computer program product of claim 14, wherein searching the presentation repository includes estimating the relevance of a candidate slide to the query by using a combination of a cosine similarity function and a Boolean similarity function.

19. The computer program product of claim 14, wherein receiving the target outline for the target presentation includes repeating the generating, searching and presenting steps to keep the search results up-to-date.

20. The computer program product of claim 14, further comprising receiving user indication to add one or more of the matching presentation slides to the target presentation.
